(19) United States
(12) Patent Application Publication
(10) Pub. No.: US 2025/0183464 A1
(43) Pub. Date: Jun. 5, 2025

(54) ENERGY STORAGE SYSTEMS AND ASSOCIATED METHODS

(71) Applicant: Powin, LLC, Tualatin, OR (US)

(72) Inventors: Rody Myron Hardy, Portland, OR (US); Karl James Plank, Lake Oswego, OR (US)

(73) Assignee: Powin, LLC, Tualatin, OR (US)

(21) Appl. No.: 18/725,710

(22) PCT Filed: Dec. 30, 2022
(86) PCT No.: PCT/US2022/054375

§ 371 Date: Jun. 28, 2024

Related U.S. Application Data
(60) Provisional application No. 63/295,721, filed on Dec. 31, 2021.

(51) Int. Cl. H01M 50/333; H01M 10/48; H01M 10/613; H01M 10/627; H01M 10/6563; H01M 10/6566; H01M 50/251; H01M 50/375

(52) U.S. Cl. CPC H01M 50/333; H01M 10/486; H01M 10/613; H01M 10/627; H01M 10/6563; H01M 10/6566; H01M 50/251; H01M 50/375; H01M 2200/10; H01M 2220/10

(57) ABSTRACT

An energy storage system includes an enclosure having a vent forming a flow path between an interior volume of the enclosure and an environment exterior to the enclosure. A vent covering is mounted proximate the vent and is selectively disposable over the vent such that the flow path is open when the vent covering is in an open position and closed when the vent covering is in a closed position. The vent covering can be biased to the open position and/or made of a thermally decomposable material. An actuator is coupled to the vent covering such that supply of power to the actuator causes the vent covering to assume the closed position and loss of power to the actuator causes the vent covering to assume the open position. A method comprises detecting a flammable gas and opening a first flow path by a first vent of the enclosure.

### CROSS-REFERENCE TO RELATED APPLICATION

This application claims priority to U.S. Provisional Application No. 63/295,721, filed on Dec. 31, 2021, which is incorporated by reference herein in its entirety.

### FIELD

The present disclosure relates generally to battery energy storage systems, and more specifically to energy storage systems with venting features and associated methods.

### BACKGROUND

Battery energy storage systems (BESS) can store energy, including energy from renewable sources, and release the stored energy for consumption when needed. High performance BESS have been developed and deployed for different grid applications, such as micro-grids, off-grid systems, demand side management, electric service reliability, and energy arbitrage.

Materials used in BESS, including those based on lithium-ion technology, can provide high energy and power densities, in some cases at levels suitable for grid applications. However, BESS materials can present dangers, such as fire, explosion, or the release of toxic substances, under certain conditions. For example, lithium-ion cells can undergo thermal runaway during failure events. Thermal runaway results in a rapid increase in the temperature of the cell. As the temperature of the lithium-ion cell rises during thermal runaway, the cell releases hazardous and/or flammable gases, such as hydrogen, hydrocarbons, carbon monoxide, and carbon dioxide. The combination of the high temperature of the cell and the flammability of the released gases can create a condition in which fires can readily occur. The higher the state of charge (SOC) of the cell, the greater the volume of gases the cells can release and the greater the flammability range of the gases.

There exists a need to build BESS that can mitigate issues related to dangerous conditions, such as conditions resulting from thermal runaway.

### SUMMARY

Energy storage systems and associated methods are disclosed herein. In a representative example, an energy storage system comprises an enclosure comprising a first vent and a first vent covering mounted proximate the first vent. The enclosure forms a first flow path between an interior volume of the enclosure and an environment exterior to the enclosure. The first vent covering is electively disposable over the first vent such that the first flow path is open when the first vent covering is in an open position and closed when the first vent covering is in a closed position. The energy storage system further comprises an actuator coupled to the first vent covering such that supply of electrical power to the actuator causes the first vent covering to assume the closed position and loss of electrical power to the actuator causes the first vent covering to assume the open position. In some examples, the first vent covering is biased to the open position. In some examples, the first vent covering is made of a thermally decomposable material.

In another representative example, a method comprises detecting a flammable gas at a concentration above a predetermined limit within an interior volume of an enclosure and, responsive to the detecting the flammable gas, opening a first flow path formed between an interior volume of the enclosure and an environment exterior to the enclosure by a first vent of the enclosure.

### BRIEF DESCRIPTION OF THE DRAWINGS

FIG. 1 is a block diagram of a battery energy storage system, according to one example.

FIG. 2 is a block diagram of an augmented battery energy storage system, according to another example.

FIG. 3 is a block diagram of a battery stack, according to one example.

FIG. 4 is a block diagram of a battery pack, according to one example.

FIG. 5A is a perspective view of a battery segment, according to one example.

FIGS. 5B-5D are different side views of the battery segment, according to one example.

FIG. 5E is a cross section of the battery segment along line 5E-5E as depicted in FIG. 5B.

FIG. 6A is a portion of an enclosure illustrating a vent covering mounted to a side of the enclosure.

FIG. 6B is a detail cut-away view of the vent covering as depicted in FIG. 6A in an open position.

FIG. 7 is a plot illustrating a battery gas release profile, according to one example.

FIG. 8 is a cross section of the battery segment as depicted in FIG. 5E illustrating positioning of battery gas release and gas detectors for a ventilation analysis, according to one example.

FIG. 9 is a plot showing battery gas concentration as a function of time for a forced/active ventilation mode.

FIG. 10 is a plot showing battery gas concentration as a function of time for a natural/passive ventilation mode.

FIG. 11 is a plot showing battery gas concentration as a function of time for a sealed/no ventilation mode.

### DETAILED DESCRIPTION

### General Considerations

For purposes of this description, certain aspects, advantages, and novel features of the examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

All features described herein are independent of one another and, except where structurally impossible, can be used in combination with any other feature described herein.

In the following description, certain terms may be used such as “up,” “down,” “upper,” “lower,” “top,” “bottom,” “horizontal,” “vertical” “left,” “right,” and the like. These terms are used, where applicable, to provide some clarity of description when dealing with relative relationships. These terms are not, however, intended to imply absolute relationships, positions, and/or orientations. For example, with respect to an object, an “upper” surface can become a “lower” surface simply by turning the object over. Nevertheless, it is still the same object.

Unless otherwise indicated, all numbers expressing dimensions (e.g., heights, widths, lengths, etc.), angles, quantities of components, percentages, temperatures, forces, times, and so forth, as used in the specification or claims, are to be understood as being modified by the term “about.” Accordingly, unless otherwise indicated, implicitly or explicitly, the numerical parameters set forth are approximations that can depend on the desired properties sought and/or limits of detection under test conditions/methods familiar to those of ordinary skill in the art. Furthermore, not all alternatives recited herein are equivalents.

As used herein, the terms “selective” and “selectively,” when modifying an action, movement, configuration, or other activity of one or more components or characteristics of an apparatus, mean that the specific action, movement, configuration, or other activity is a direct or indirect result of one or more dynamic processes, as described herein. The terms “selective” and “selectively” thus may characterize an activity that is a direct or indirect result of user manipulation of an aspect of, or one or more components of, the apparatus, or may characterize a process that occurs automatically, such as via the mechanisms disclosed herein.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function, but rather that the element, component, and/or other subject matter is specifically selected, created, implemented, utilized, programmed, and/or designed for the purpose of performing the function. It also is within the scope of the present disclosure that elements, components, and/or other recited subject matter that is recited as being adapted to perform a particular function additionally (or alternatively) may be described as being configured to perform that function, and vice versa. Similarly, subject matter that is recited as being configured to perform a particular function additionally (or alternatively) may be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); and in yet another example, to both A and B (optionally including other entities). These entities may refer to elements, actions, structures, steps, operations, values, and the like.

As used herein, the phrase “at least one,” in reference to a list of one or more entities, should be understood to mean at least one entity selected from any one or more of the entities in the list of entities, but not necessarily including at least one of each and every entity specifically listed within the list of entities and not excluding any combinations of entities in the list of entities. This definition also allows that entities optionally may be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one example, to at least one, optionally including more than one, A, with no B present (and optionally including entities other than B); in another example, to at least one, optionally including more than one, B, with no A present (and optionally including entities other than A); and in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase, “for example,” the phrase, “as an example,” and/or simply the term “example,” when used with reference to one or more components, features, details, structures, examples, and/or methods according to the present disclosure, are intended to convey that the described component, feature, detail, structure, example, and/or method is an illustrative, non-exclusive example of components, features, details, structures, examples, and/or methods according to the present disclosure. Thus, the described component, feature, detail, structure, example, and/or method is not intended to be limiting, required, or exclusive/exhaustive; and other components, features, details, structures, examples, and/or methods, including structurally and/or functionally similar and/or equivalent components, features, details, structures, examples, and/or methods, are also within the scope of the present disclosure. In this manner, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language.

### Examples of the Disclosed Technology

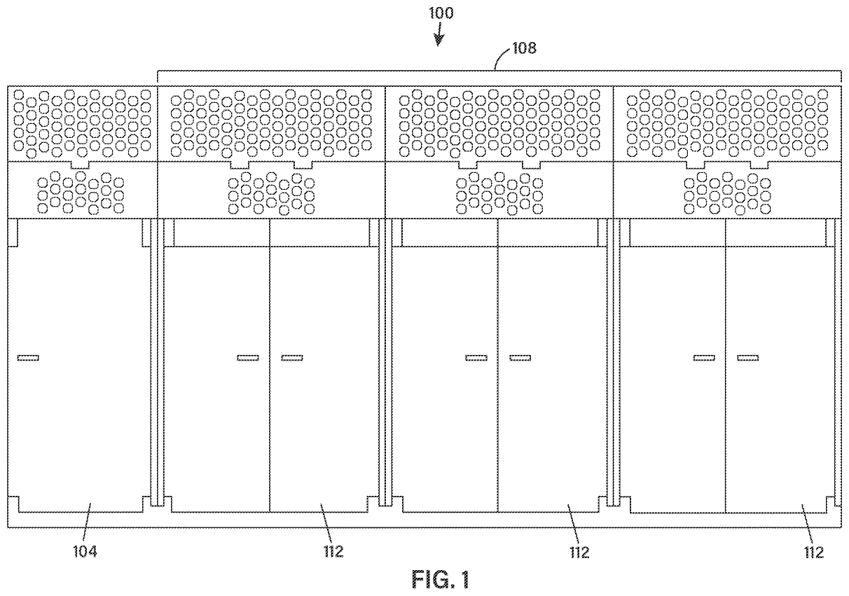

FIG. 1 illustrates a battery energy storage system (BESS) 100, according to one example. BESS 100 can be operated as a standalone system or can be part of a network of energy storage systems, which can include other BESSs. BESS 100 captures energy and stores the energy for use at a later time. The stored energy can come from various sources, such as renewable energy sources (e.g., solar, wind, etc.). BESS 100 can include a collection segment 104 and an energy storage array 108 including one or more battery segments 112. For the sake of simplicity, FIG. 1 illustrates three battery segments 112; however, it is to be understood that the energy storage array 108 can have any suitable number of battery segments 112. In various, the energy storage array 108 can include between one and twenty battery segments 112. As a more specific example, the energy storage array 108 can include around four to six battery segments 112. Although FIG. 1, and the present disclosure in general, are described as relating to BESS, it should be appreciated that disclosed technologies can be used with other components stored in a housing and where fire, explosion, or similar hazards may exist.

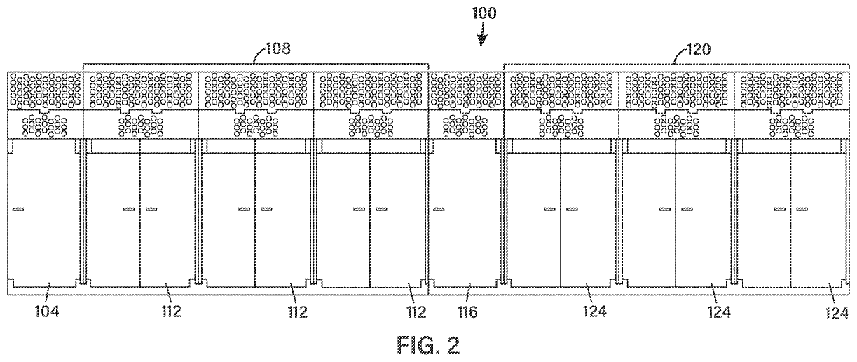

As shown in FIGS. 1-2, the collection segment 104 and the battery segments 112 can be in the form of modules that can be concatenated to form the BESS 100. As a result, the BESS 100 can be highly scalable. In a representative example, each battery segment 112 can be configured with a power capacity of 750 kWh. If the BESS 100 can have up to twenty such battery segments, for example, then the BESS 100 can be configured with a power capacity in a range from 750 kWh to 15 MWh, according to one example. A grid-sized BESS can be defined as having a power capacity of 1 MWh or larger. Thus, with fewer than twenty battery segments, a grid-sized BESS can be configured.

In some cases, as shown in FIG. 2, the BESS 100 can include an augmentation segment 116 that allows a new energy storage array 120 to be daisy chained to the initial energy storage array 108 of the BESS 100, extending the power capacity of the BESS 100. The new energy storage array 120 can have any number of battery segments 124 (e.g., up to twenty battery segments and/or around four to six battery segments). The battery segments 124 in the new energy storage array 120 can have the same or a different power capacity compared to the battery segments 112 in the initial energy storage array 108. The augmentation segment 116 as well as the battery segments 124 can be in the form of modules that can be concatenated to the initial configuration of the BESS 100.

It is to be understood that FIGS. 1-2 represent simplified depictions of the respective BESSs 100 and are not necessarily shown to scale. For example, the relative sizes of the collection segment 104, the augmentation segment 116, and/or the battery segments 112/124 can differ from those shown in FIGS. 1-2.

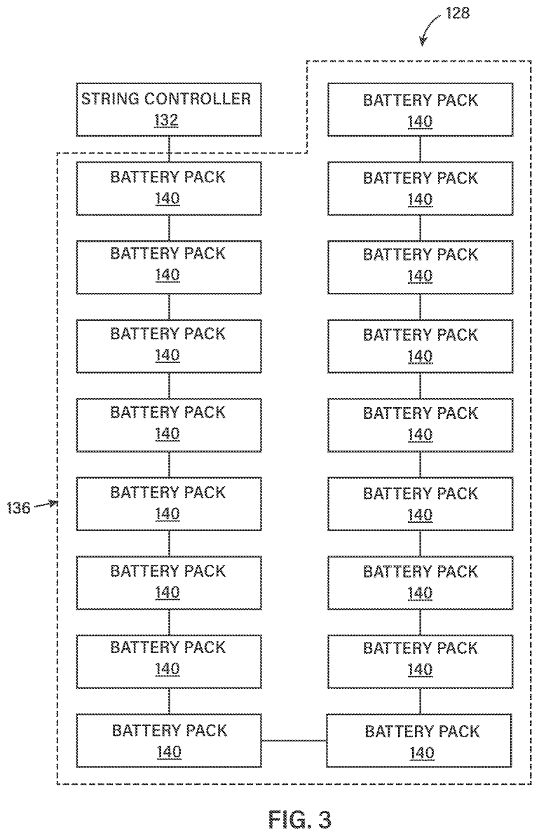

Each battery segment 112 (124) can include one or more battery stacks in parallel. FIG. 3 illustrates a battery stack 128, according to one example. The battery stack 128 can include a string controller 132 and a battery string 136. The battery string 136 includes a plurality of battery packs 140 connected in series. Any number of battery packs 140 can be included in the battery string 136. For example, FIG. 3 illustrates an example in which the battery string 136 includes seventeen battery packs 140. In other examples, the battery string 136 can include more or fewer battery packs 140 than in the example of FIG. 3. In various examples, the number of battery packs 140 included in the battery string 136 can be selected based, at least in part, on one or more practical and/or operational considerations (e.g., an operational limit of the total voltage of the battery string 136). As a more specific example, the configuration of the battery string 136 can be constrained by a maximum operational voltage of 1500 VDC, which can correspond to a number within a range of about one to fourteen battery packs 140. In another example characterized and/or constrained by a higher operational voltage (e.g., a maximum operational voltage of 1800 VDC-2000 VDC or higher), the battery string 136 can include a greater number of battery packs 140 without exceeding such an operational voltage. The battery string 136 can be in communication with the string controller 132, which can be in communication with higher level systems, such as a battery management system (BMS), thermal management system (TMS), and energy management system (EMS).

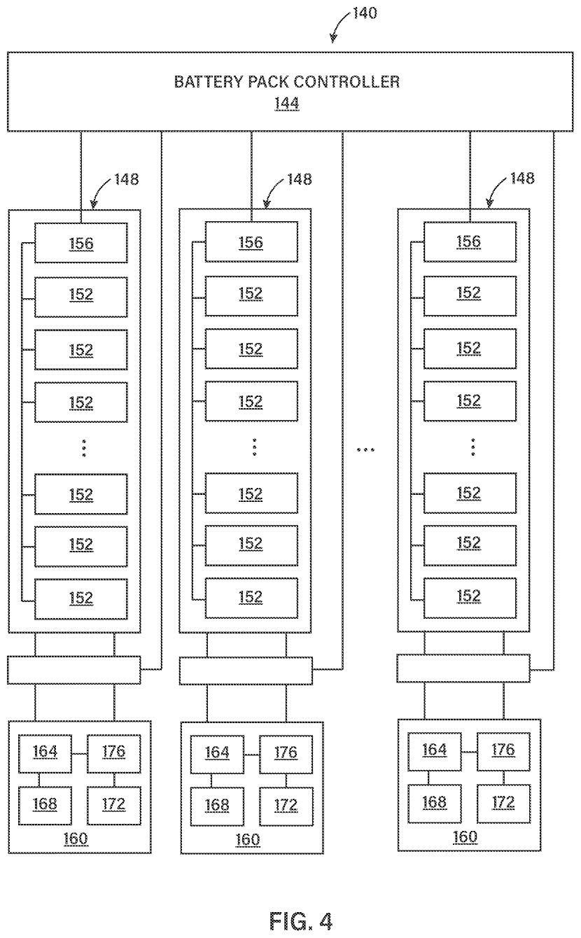

As illustrated in FIG. 4, each battery pack 140 can include a battery pack controller 144 and a plurality of battery modules 148. Each of the battery modules 148 includes a plurality of battery cells (simply, cells) 152. In one example, the cells 152 can be based on lithium-ion technology. In some cases, the cells 152 can be organized into cell groups, each cell group having two or more cells 152. The cells 152 can be contained in a mechanical casing with appropriate thermal features, such as heat sink, to transfer heat generated by the cells to a fluid medium, such as circulating air. The battery modules 148 can include a cell monitor unit (CMU) 156 that measures various cell parameters, such as cell voltage and cell temperature. The CMU 156 can communicate measured data to the battery pack controller 144.

The battery pack 140 can further include balance chargers/dischargers 160 configured to charge and discharge the cells 152 in the battery modules 148. In one example, a balance charger/discharger 160 can include a charge relay 164 connected to a voltage source 168 and a load 172 connected to a discharge relay 176. The discharge relay 176 can be connected to the charge relay 164. The charge relay 164 and discharge relay 176 can be connected to the battery module 148. The battery pack controller 144 can control operation of the balance charger/discharger 160 according to a balance strategy, which can be provided by the string controller 132. Additional details about the balance charger/discharger can be found in U.S. Patent Application Publication No. 2021/0218250, which is incorporated herein by reference.

Failure modes of the cells can cause the cells to release gases that will have flammable and explosive potential if collected in sufficient concentrations within the battery system enclosure. There are two typical methods to handle this situation: (1) an active venting system that will detect the presence of the gases and activate a vent system that will use a fan to bring in fresh external air into the battery enclosure and exhaust the gases out of the enclosure, diluting the gases and lowering the risk of explosion; and (2) an explosion deflagration system that employs panels that open when pressure from an actual explosion occur, directing the force of the explosion away from the area personnel may be and relieving the pressure of the explosion that could result in destruction of the enclosure and danger to personnel and equipment in the vicinity. On large battery systems with the equivalent enclosure size of 40- and 53-foot cargo containers, it is common to pair active venting with deflagration as a backup method in the case of loss of power or damage to the active venting system. This can be an effective solution for large enclosure systems as the large airspace within the enclosure allows for the effective implementation of deflagration panels due to the lower global concentrations of explosive gases and lower explosion forces.

With large scale battery systems, there is a high density of battery cells contained within a small space (i.e., regardless of the size of an enclosure, a space can be considered small if the volume taken up by the batteries represents a large portion of the available volume, and the unfilled volume of the enclosure is comparatively low). In a small form factor modular type battery system, there is limited free airspace within the enclosure, and typical gas concentrations from a cell failure, if not vented to fresh air, can rise to levels where deflagration is not effective and damage and increased risk to personnel is likely. In addition, there are increased risks of explosion risks due to fires in or near the battery system. Gases not vented from an enclosure are an explosion risk for an outside fire. An internal fire can damage cells, causing cell failures and the release of explosive gases within the enclosure. In the event that an internal fire is extinguished by fire suppression, or is smothered due to lack of airflow, the production of explosive gases can continue within the container until first responders interact with the container.

A ventilation system is described herein for the modular battery segment 112 (124) that protects against one or more threats, and in some implementations against multiple threats. The ventilation system can include an active mode that is activated when explosive gases are detected within an enclosure. In one example of an active mode, activation of the active mode turns on one or more fans that can force fresh external air into the enclosure and through the cells.

The ventilation system can also include one or more passive modes that can respond to threats when operation of the battery segment is compromised. In one example of a passive mode, upon loss of electrical power caused by partial or full system failure, damage from fire, or intentional removal of electrical power by first responders, electronically-actuated vent coverings that provide fresh air input and/or gas exhaust paths are designed to fail in an open position. In other words, the vent coverings are biased towards an open position and are electronically-actuated into the closed position, where loss of electrical power causes loss of actuation into the closed position and the biasing action causes the vent covering to assume the open position.

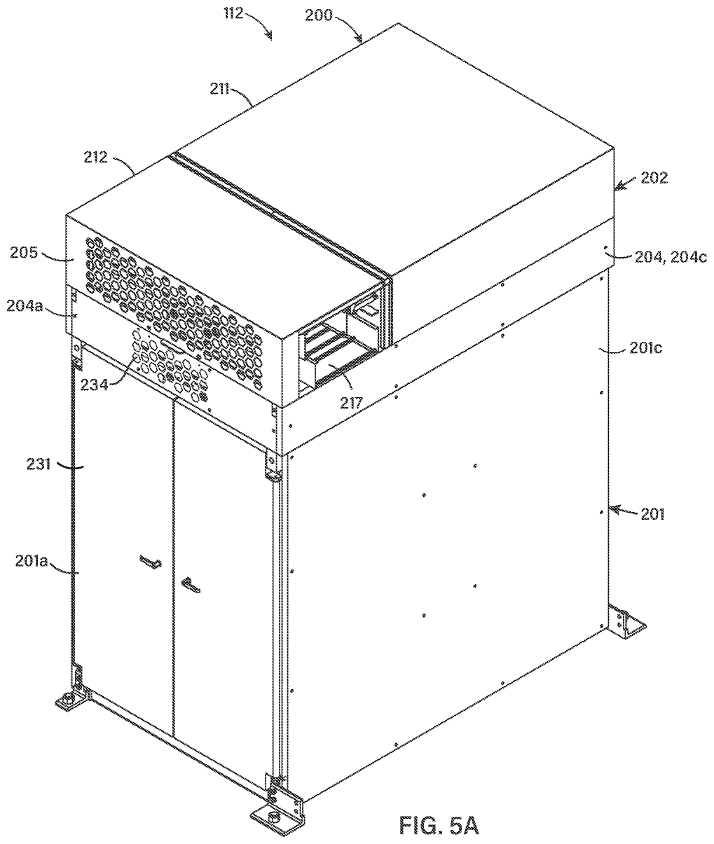

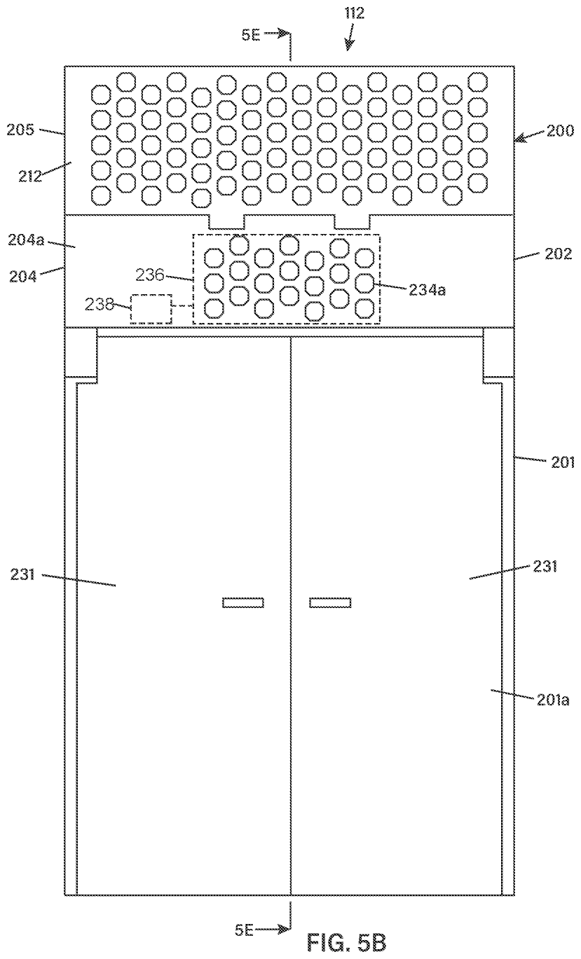

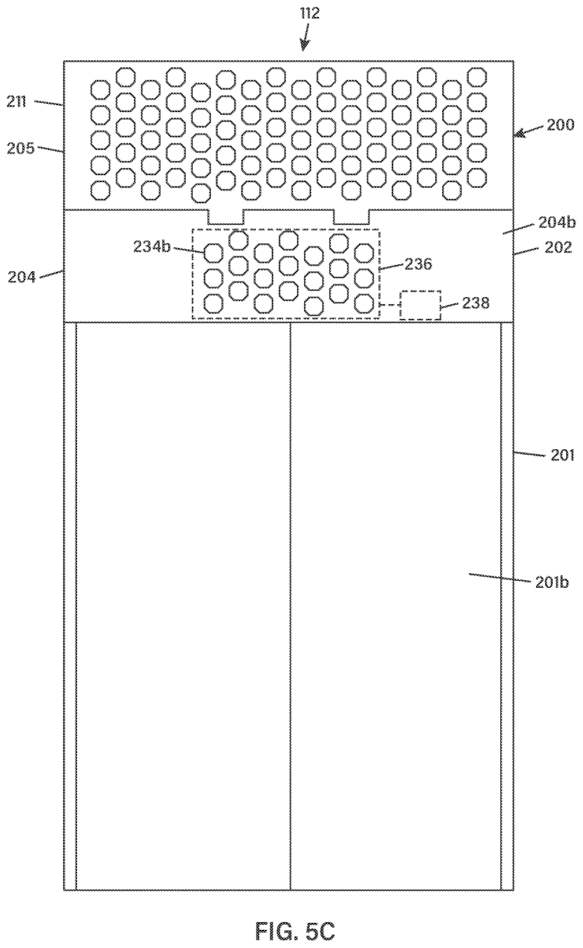

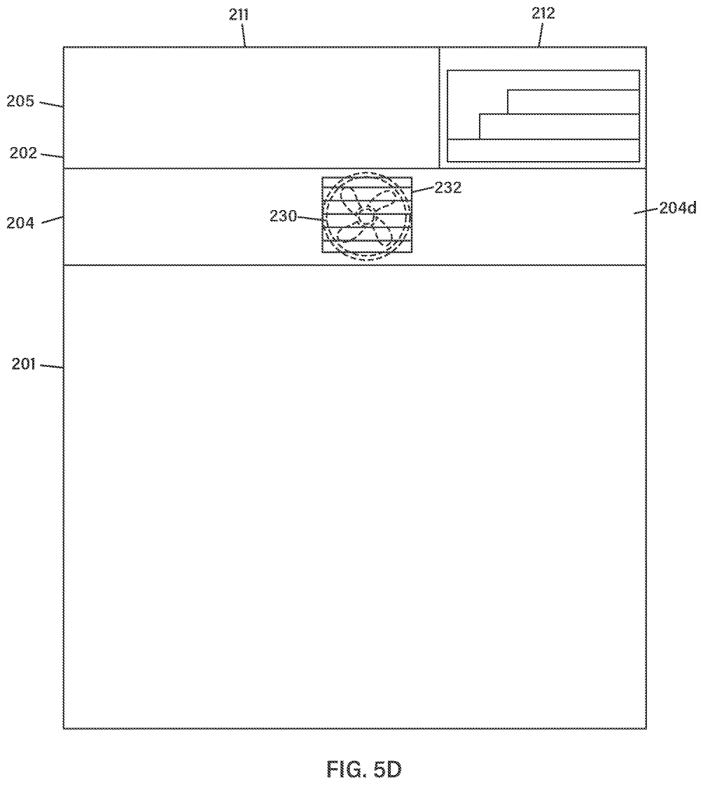

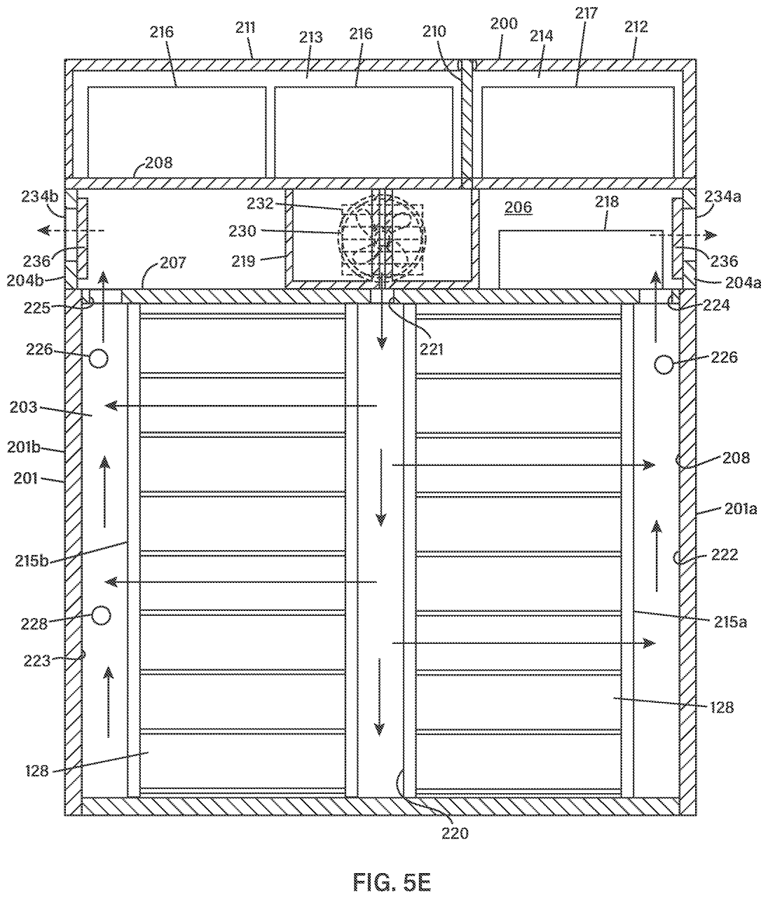

In the open position, exhaust vents, which are located in the upper airspace of the enclosure, allow for passive exhaust ventilation of the hot and typically lighter than the surrounding air to the outside, reducing the concentrations of the gases in the enclosure and the associated explosion risks. Examples of exhaust vents for passive and/or active venting are described in more detail below with reference to the exhaust vents 232, 234, 234a, and 234b shown in FIGS. 5A-5E.

At least after a fire event has progressed to a certain point, electrical power is not typically available. Electrical power failure can occur because of automatic operation of the BESS (e.g., power is disconnected where fire is detected) or because the fire damaged power transmission components. The failsafe passive venting mode reduces the risks to fire damaged cells that may still be in a failure mode and still venting explosive gases by allowing gases a path to exit the enclosure.

The ventilation system also enables a path for fire. When fire suppression is not used or is not effective, it is recommended to have the fire burn up all the energy and gases in the battery enclosure to avoid the explosion risk. In this case, the fire needs to have a path for burning and/or for combustion inputs (e.g., air) that ensures it will not be smothered and will limit the risks of spreading to other equipment located nearby. The failsafe passive venting achieves this by steering the smoke and heat and a flow path to centrally located exhaust vents built into the battery enclosure, allowing the fire to continue to burn and limiting exposure to other batteries.

The ventilation system can use redundancy for exhaust venting. For example, two active failsafe exhaust vents located on either side of the battery enclosure can be used. The vents are connected to the same airspace so that if one of the vents is blocked or jammed, the active or passive venting is still effective.

During or after a fire event, the passive venting locations (e.g., the exhaust vents) can also be used as a target location for water by first responders to control the fire or reduce heat after the majority of the battery cells are determined to be consumed by fire and no longer at risk of releasing gases.

FIGS. 5A-5E illustrate the battery segment 112 with an active-passive ventilation system that can protect against one, or in some cases, multiple threats due to gas release during thermal runaway or other failure event, according to one example. In the illustrated example, the battery segment 112 includes an enclosure 200, which can have a lower enclosure 201 and an upper enclosure 202. The lower enclosure 201 and the upper enclosure 202 can be portions of a single housing or separate housings that are coupled together. In some cases, the upper enclosure 202 can be removably attached to the lower enclosure 201. In other cases, the upper enclosure 202 and the lower enclosure 201 can be integrally formed (e.g., connected together so as to make a single complete piece or unit that is incapable of being easily dismantled without destroying the integrity of the piece or unit). The enclosure 200 can include a structural frame to which panels and hoods are mounted to provide the lower enclosure 201 and the upper enclosure 202. The enclosure 200 can be made of fire-resistant material, such as steel.

The lower enclosure 201 can have sides/walls 201a, 201b, 201c, 201d defining a chamber 203. The side/wall 201a of the lower enclosure 201 can have an opening in which one or more doors 231 are mounted to provide controlled access to the chamber 203. The upper enclosure 202 can have an upper enclosure bottom 204 and an upper enclosure top 205. In some cases, the upper enclosure bottom 204 and the upper enclosure top 205 can be portions of a single housing or can be separate housings that are coupled together. The upper enclosure bottom 204 can have sides/walls 204a, 204b, 204c, 204d defining a plenum 206. A plenum base 207 can be arranged between the lower enclosure 201 and the upper enclosure bottom 204 to form a base of the plenum 206.

A wall 208 can be arranged between the upper enclosure bottom 204 and the upper enclosure top 205 to form a base of the upper enclosure top 205 and a roof of the plenum 206. The upper enclosure top 205 can have a support 210 attached to the wall 208. The upper enclosure top 205 can have housings 211, 212 attached to opposite sides of the support 210. A chamber 213 can be defined by the housing 211, support 210, and wall 208. A chamber 214 can be defined by the housing 212, support 210, and the wall 208. In one example, the housings 211, 212 can be hoods coupled to the support 210 by hinges.

As illustrated in FIG. 5E, in one example, one or more racks, e.g., racks 215a, 215b, can be installed inside the chamber 203 of the lower enclosure 201. Each of the racks 215a, 215b can hold the components of a battery stack 128. The racks 215a, 215b can be spaced apart to define a central supply passage 220 within the chamber 203. The supply passage 220 can receive a supply of air from the plenum 206, e.g., through an opening 221 in the plenum base 207. The racks 215a, 215b can be spaced from adjacent walls 201a, 201b of the lower enclosure 201 to define return passages 222, 223, which can communicate with the plenum 206 through openings 224, 225 in the plenum base 207. Air can move from the central passage 220 to the return passages 222, 223 through spaces in the racks 215a, 215b.

The plenum 206 and chambers 213, 214 within the upper enclosure 202 can hold other components of the battery segment 112. For example, the chamber 213 can contain one or more HVAC units 216, and the chamber 214 can contain a cable tray 217 and other structures for making electrical connections between adjacent battery segments. The plenum 206 can contain a control unit 218, a duct 219, and other structures. In one example, the HVAC units 216 can communicate with the duct 219 through openings in the wall 208. The duct 219 can communicate with the chamber 203 through openings in the plenum base 207. For example, the duct 219 can supply air to the supply passage 220 through the opening 221. In some cases, the control unit 218 can be in communication with string controllers of the battery stacks 128 within the chamber 203.

In one example, one or more cells of the battery stack 128 may undergo thermal runaway during a failure event. The thermal runaway might be accompanied by release of one or more gases and/or a flammable gas mixture thereof. For example, the gas mixture can contain one or more of hydrogen, total hydrocarbons (e.g., methane and propane), carbon dioxide, or carbon monoxide. The lower flammability limit (LFL) of the gas mixture defines the lowest concentration range over which the gas mixture when mixed with air can be ignited at a given temperature and pressure. For example, the LFL of lithium ion cells can be about 6.14%. The safe LFL limit to avoid fires is typically specified as 25% of the LFL (e.g., 1.535% in the case of cells with an LFL of 6.14%).

In one example, the battery segment 112 includes a ventilation system that is configured to protect against one, or in some cases, multiple threats due to gas release during thermal runaway or other failure event. The ventilation system can operate to maintain the gas concentration within the enclosure 200 at or below the safe LFL limit to avoid fires within the enclosure 200. In the event that fire occurs within the enclosure 200, the ventilation system can allow the fire to be dissipated in a controlled manner that mitigates damage to neighboring battery segments.

In one example, the ventilation system can include one or more gas detectors 226 positioned within the chamber 203 to measure gas concentration. For example, the gas detectors 226 can include one or more of H₂ detector, CO detector, CO₂ detector, or THC (total hydrocarbons) sensor. From the measurements of the gas detectors 226, the LFL of the gas mixture within the chamber 203 can be determined. In one example, one or more temperature sensors 228 can be positioned within the chamber 203 to measure temperature within the chamber 203. Alternatively, temperature measurements can be obtained from sensors integrated with the battery stacks 128.

In one example, the ventilation system can include one or more fans 230 that can be operated to pull fresh external air into the enclosure 200 when the measurements of the gas detectors 226/temperature sensors 228 indicate that the concentration of a flammable gas mixture within the chamber 203 is approaching the safe LFL limit and/or the temperature within the chamber 203 has exceeded a predetermined limit. For example, where the safe LFL limit is 1.535%, the fan(s) 230 can be operated when the concentration of a flammable gas mixture within the chamber 203 is about 1%. In some cases, the gas detectors or temperature sensors can be used to perform other tasks, such as disconnecting the batteries from external components (e.g., upstream or downstream electrical power supply components), or to proactively cause a passive mode threat mitigation system to become operational (e.g., de-powering an actuator such that a vent covering assumes an open configuration).

The upper enclosure bottom 204 can include a vent 232. For example, the vent 232 can be formed in the wall 204d of the upper enclosure bottom 204 (shown in FIG. 5D). The fan(s) 230 can be positioned proximate the vent 232 to draw air into the plenum 206 through the vent 232. In one example, the fan(s) 230 can be positioned between the duct 219 and the vent 232 to pull air through the vent 232 into the duct 219, and the air in the duct 219 can be discharged into the central passage 220 within the chamber 203. The air can circulate around the cells in the chamber 203 and return to the plenum 206 through the return passages 222, 223. In another example, the fan(s) 230 can be positioned in order to push air from the duct 219 to the exterior of the enclosure 200 through the vent 232.

In one example, the string controller of a battery stack 128 within the chamber 203 can receive the measurements made by the gas detectors 226/temperature sensors 228 and determine the air flow rate of the fan(s) 230 that would reduce the concentration of the flammable gas mixture or temperature within the chamber 230. In some cases, the string controller can provide the desired air flow rate to the control unit 218, which can then operate the fan(s) 230 to produce the desired air flow rate. In other cases, the control unit 218 can receive the sensor measurements directly and determine the air flow rate for the fan(s) 230.

The fan(s) 230 can be configured to produce any of a variety of flow rates. In one example, the speed of the fan(s) 230 can be controlled to produce an air flow rate in a range from 200 to 300 cubic feet per minute (CFM). As other examples, the fan(s) 230 can be configured and/or controlled to produce an air flow rate in a range from about 50 to 150 CFM, 100 to 200 CFM, 300-500 CFM, or more than 500 CFM. In practice, the fan(s) 230 and/or the controlled flow rates thereof can be selected and/or configured based upon any of a variety of considerations, such as a volume of the enclosure 200 to be vented, a maximum time in which air in the volume of the enclosure 200 is to be replaced, power draw considerations, size constraints, etc.

One or more exhaust vents, e.g., exhaust vents 234a, 234b, can be in communication with the plenum 206. For example, the exhaust vents 234a, 234b can be formed in the opposing walls 204a, 204b of the upper enclosure bottom 204. Each exhaust vent 234a, 234b can be a single large opening or can include a plurality of openings. The exhaust vents 234a, 234b can occupy a central portion of the corresponding wall 204a, 204b or can extend across the entire width and length of the corresponding wall 204a, 204b. The exhaust vents 234a, 234b can allow air and flames (in the event of an explosion within the enclosure 200) to be vented out of the plenum 206. The exhaust vents 234a, 234b can be located on walls that are orthogonal to the wall on which the vent 232 is located. In general, vents can be included at positions and at sufficient numbers and dimensions in order to provide a desired degree of egress for gas and fire, or for ingress of fresh air, or to provide a flow path within the enclosure for gas, fire, or fresh air. For example, in some cases, it can be beneficial to locate vents at positions in the enclosure where the vents will not be blocked and where dangerous materials, such as fire or gases, exiting the enclosure will be less likely to come into contact with personnel or with other equipment that might be located proximate the enclosure.

A vent covering 236 (e.g., louver, flapper, damper, shutter, etc.) can be positioned proximate to each of the exhaust vents 234a, 234b to selectively control flow through the exhaust vents 234a, 234b. The vent covering 236 can be adjustable between an open position and a closed position by an actuator 238, which can be in communication with the control unit 218. In the open position, the vent covering 236 can allow venting of air and/or flames that enter the plenum 206 from the chamber 203. The exhaust vents 234a, 234b, formed in the upper enclosure 202 or upper/top airspace of the enclosure 200, can encourage upward movement of the air and/or flames away from the battery stacks 128 in the chamber 203.

The vent covering 236 can be normally open and power close such that if there is no electrical power supply to the actuator 238 the vent covering 236 will automatically open to allow venting of air and/or flames from the plenum 206. In some cases, the vent covering 236 can be made of thermally decomposable material such that if the vent covering 236 does not open (e.g., because the vent covering 236 is powered to the closed position by the actuator 238), hot air and/or flames can decompose the vent covering 236 to allow venting of the air and/or flames from the plenum 206 to the exterior of the enclosure 200. For example, the thermally decomposable material can be materials with relatively low melting point, such as, for example, aluminum or plastic. In general, the thermally decomposable material can be any material that can suitably regulate the flow of air through the vent and that can decompose (e.g., melt) before a threshold is reached (e.g., the material melts or otherwise decomposes at a temperature produced when a fire of sufficient severity is present within the enclosure 200).

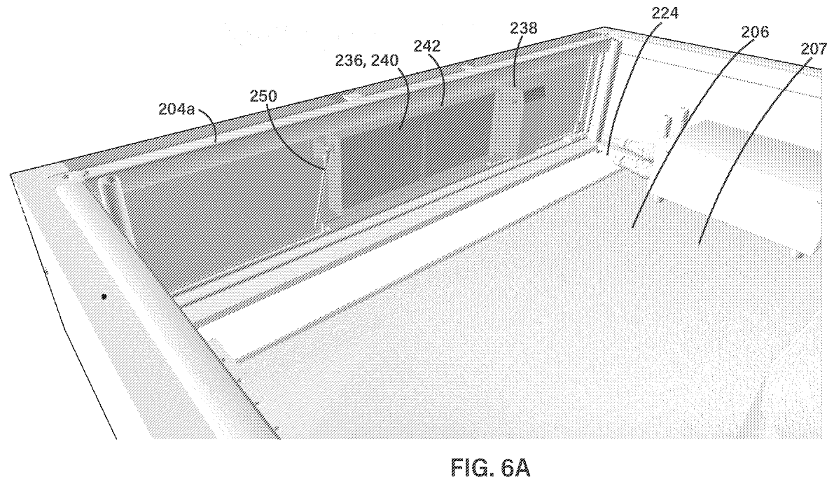

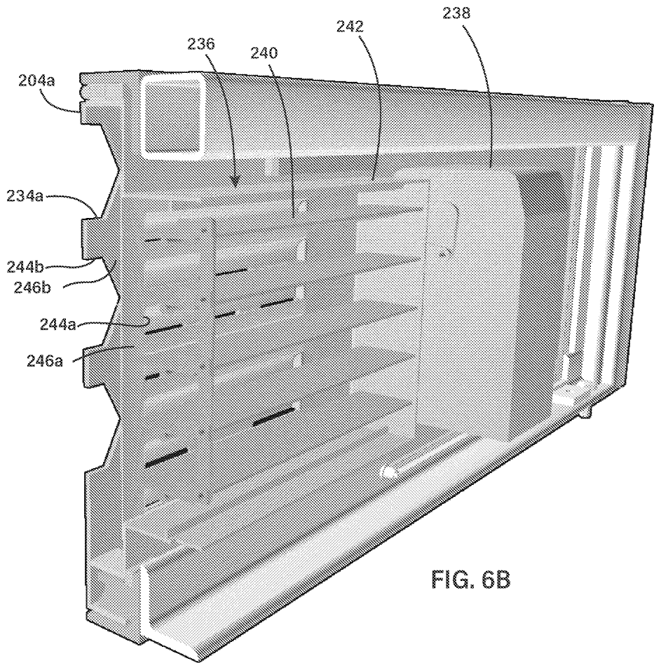

FIGS. 6A and 6B illustrate one example of the vent covering 236 mounted to an inner side of the wall 204a of the upper enclosure bottom 204 to cover the exhaust vent 234a formed in the wall 204a (the same arrangement can be provided for the exhaust vent 234b formed in the wall 204b). In the example, the vent covering 236 includes a louver 240 mounted within a frame 242. The frame 242 can be mounted to the wall 204a such that the louver 240 is disposed proximate the exhaust vent 234a.

In the example, the exhaust vent 234a includes openings 244a in a first layer 246a of the wall 204a and openings 244b in a second layer 246b of the wall 204a. The second layer 246b is disposed parallel to the first layer 246a and spaced from the first layer 246a by an air gap. In one example, the frame 242 and louver 240 can be mounted on the side of the first layer 246a exposed to the plenum 206. In another example, the frame 242 and louver 240 can be mounted on the side of the second layer 246b exposed to the outside of the upper enclosure bottom 204. The frame 242 can be mounted such that the louver 240 can close the exhaust vent 234a from inside the upper enclosure bottom 204 or from outside the upper enclosure bottom 204.

As illustrated in FIG. 6A, the plenum base 207 can include an opening 224 that connects the plenum 206 to the chamber 203 of the lower enclosure 201. Air and/or flames from the chamber 203 can enter the plenum 206 through the opening 224. The opening 244 can be disposed proximate to the wall 204a of the upper enclosure bottom 204 where the exhaust vent 234a is located. When the louver 240 is open, the air and/or flames entering the plenum 206 through the opening 224 can be directed outside of the plenum 206 through the louver 240 and exhaust vent 234a.

The louver 240 can be normally open by action of a biasing member 250 (e.g., a spring loaded rod), which can be coupled to the louver 240 via the frame 242. The actuator 238 can be coupled to the louver 240 (e.g., via the frame 242) to operate the louver 240. When electrical power is supplied to the actuator 238 (e.g., by the control unit 218), the actuator 238 can operate to close the louver 240. When there is loss of electrical power to the actuator 238, the louver 240 automatically opens (e.g., by action of the biasing member 250). Similar biasing members may be used for other types of vent coverings, and for vent coverings mounted proximate a vent in another way. For example, a spring can bias a slidable plate in an open position, where loss of electrical power cause the plate to slide to the surface of the enclosure 200 and cover a vent formed in the enclosure.

In one example, the louver 240 can be made of an easily meltable material, such as aluminum or plastic. This can allow the louver 240 to be melted off in a fire event where the actuator 238 is still receiving electrical power.

In one example, a method of maintaining a safe LFL limit within the enclosure 200 can include detecting battery gas release within the enclosure 200. The battery gas release can be detected using one or more gas detectors 226 in the enclosure. In one example, one or more of H₂, CO, THC, or CO₂ can be detected.

The method can include circulating fresh external air through the enclosure 200. One or more fans 230 can be operated to pull the fresh air into the plenum 206 through the vent 232. The speed of the fan(s) 230 can be controlled to produce air flow at a selected rate, e.g., a rate between 200 CFM and 300 CFM. The fan(s) 230 can pull the fresh air into the duct 219, from which the air can be supplied to the central passage 220 within the chamber 203 of the lower enclosure 201. The air can combine with gases within the chamber 203, diluting the concentration of the gases within the chamber 203. The diluted air can flow around the battery stacks 128 into the return passages 222, 223 and return to the plenum 206.

The method can include opening the exhaust vents 234a, 234b (e.g., by adjusting the vent coverings 236 to the open position) so that the air returned to the plenum 206 can be exhausted outside of the enclosure 200. The exhaust vents 234a, 234b can be opened prior to or after activating the fan(s) 230 to pull fresh external air into the enclosure 200.

In some cases, the fan(s) 230 can be activated after a predetermined delay of detecting battery gas release. For example, each gas detector 226 can have an associated delay that is used to determine when forced ventilation should be started. The delay can be based on the degree of flammability of the gas detected by the gas detector 226.

In an alternative example, as mentioned above, instead of using the fan(s) 230 to push air into the chamber 203, the fan(s) 230 can be used to pull air out of the chamber 203 into the plenum 206 or the duct 219, where the air can then be exhausted to the exterior of the enclosure 200 using one or more of the vents in communication with the plenum and/or duct.

In one example, the battery gas dispersion and the global volume fraction inside the enclosure 200 were analyzed for three scenarios: a forced/active ventilation scenario where the fan(s) 230 were operated at 200 CFM and 300 CFM and the exhaust vents 234a, 234b were open, a natural/passive ventilation scenario where the fan(s) 230 were not operated but the exhaust vents 234a, 234b were open, and a sealed enclosure/no ventilation scenario where the fan(s) 230 were not operated and the exhaust vents 234a, 234b were not open.

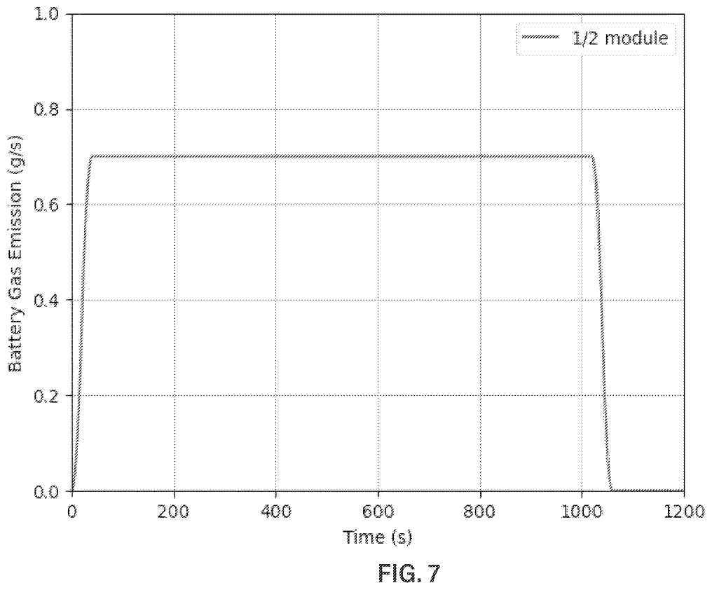

For the analysis, a failure event was assumed. The failure event included five cells overheating and releasing gas at an average rate of 0.7 g/s for a total duration of 18 minutes. Table 1 shows the battery gas composition at the start of the battery gas release. The stoichiometric concentration in air was 18.38%, the LFL in air was 6.14%, the safe LFL limit in air was 1.535%, and the temperature of the gas released was 640° C. FIG. 7 shows the battery gas release profile over 18 minutes as assumed for the analysis.

TABLE 1

| | Volume Fraction | Mass Fraction | Molar Mass | Density |
|---|---|---|---|---|
| Component | (% vol) | (% wt) | (g/mol) | (kg/m³) |
| H₂ | 49 | 4.46 | 2.016 | 0.08381 |
| THC | 13 | 25.56 | 44.10 | 1.833 |
| CO | 10 | 12.56 | 28.01 | 1.165 |
| CO₂ | 28 | 57.42 | 44.01 | 1.820 |
| Mixture | 100.0 | 100.0 | 22.0 | 0.9145 |

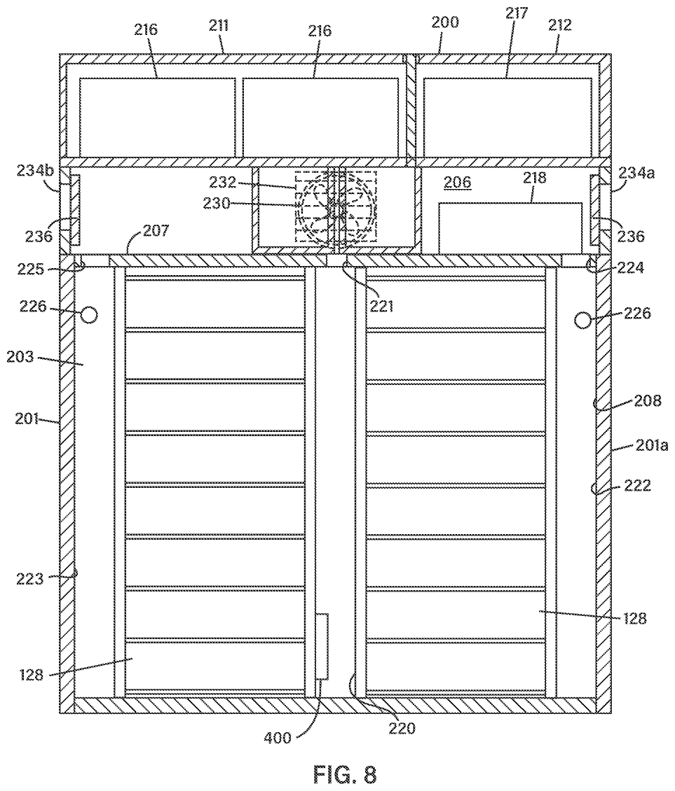

FIG. 8 shows the assumed location of the battery gas release 400 within the enclosure 200, the location of the exhaust vents 234a, 234b, the location of the supply opening 221, and the location of the gas detectors 226. For the analysis, the HVAC units 216 were not operated in order to allow identification of the time of detection of the battery gas release. The analysis assumed detection thresholds of 1000 ppm with 20 s response time for H₂ and 150 ppm with 35 s response time for CO.

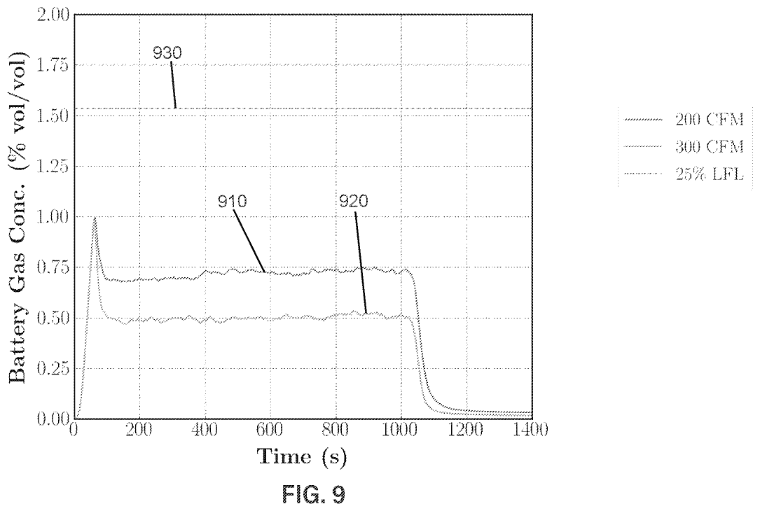

FIG. 9 shows the battery gas concentration for the scenario where the exhaust vents 234a, 234b are opened and the fan(s) 230 are operated in response to detecting battery gas release (i.e., the forced/active ventilation scenario). In this scenario, fresh air is pulled into the enclosure through the vent 232 by the fan(s) 230 and forced into the central passage 220 within the lower enclosure 201 and then returned to the plenum 206 via the passages 222, 223, where the air is exhausted out of the plenum 206 through the exhaust vents 234a, 234b. The battery gas release occurred at time 0 s and continued for 18 minutes. The CO detector was activated at 33s, and the H₂ detector was activated at 33s. The H₂ detection triggered operation of the fan(s) and opening of the exhaust vents at 58s. FIG. 9 shows the gas concentration within the enclosure with an air flow rate of the fan(s) at 200 CFM (corresponding to the data series labeled 910) and at 300 CFM (corresponding to the data series labeled 920). The analysis shows that the H₂ detector was activated before the CO detector. The analysis shows that forced/active ventilation at 200 CFM and 300 CFM adequately maintained the global average gas concentration within the enclosure below the threshold 25% LFL, indicated by the dashed line labeled 930 in FIG. 9.

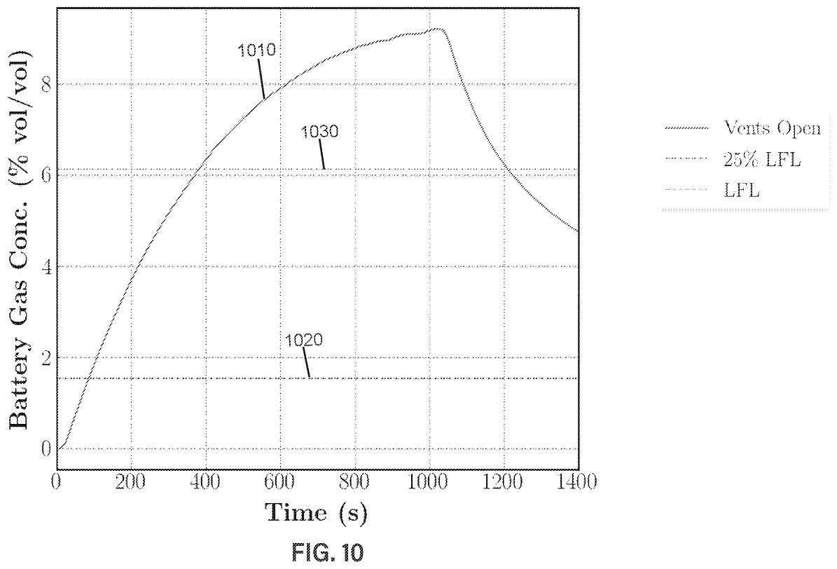

FIG. 10 shows the battery gas concentration (indicated by the data series labeled 1010) for the scenario where the exhaust vents are open from the start of the battery gas release and the fan(s) 230 were not operated in response to detecting battery gas release (i.e., natural/passive ventilation scenario). In this scenario, fresh air is not pulled into the enclosure through the vent 232, but the air (or gas mixture) in the lower enclosure 201 that reaches the plenum 206 is allowed to exit the enclosure 200 through the exhaust vents 234a, 234b. The analysis shows that the global average battery gas concentration within the enclosure reached about 10% (which is greater than the threshold 25% LFL) when natural/passive ventilation is performed with the exhaust vents opened from the start of the battery gas release but without operating the fan(s). In FIG. 10, the LFL limit is indicated by the dashed line labeled 1030, while the dashed line labeled 1020 indicates the threshold 25% LFL.

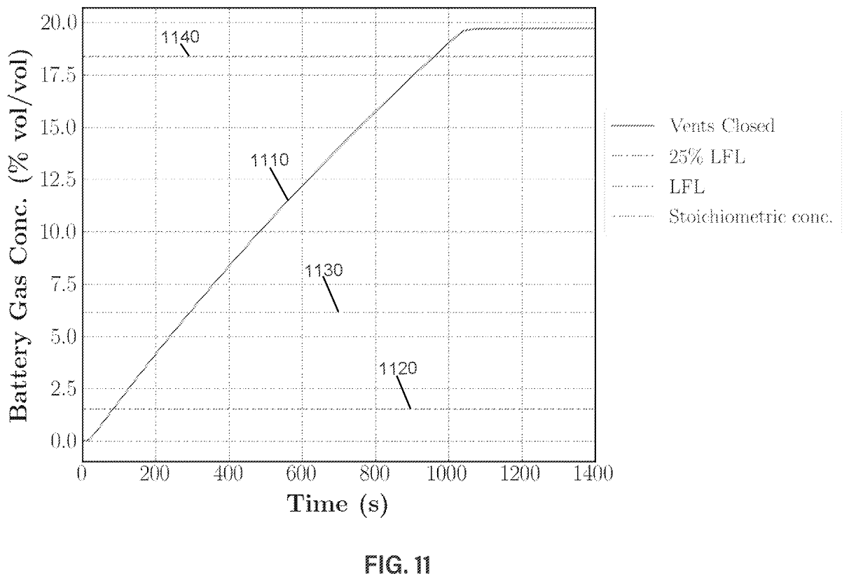

FIG. 11 shows the battery gas concentration (indicated by the data series labeled 1110) for the scenario where the exhaust vents were not opened and the fan(s) were not triggered in response to detecting battery gas release (i.e., sealed enclosure/no ventilation scenario). The global average battery gas concentration in this scenario reached a high value of 20% inside the enclosure, which is significantly higher than the threshold 25% LFL. In FIG. 11, the LFL limit is indicated by the dashed line labeled 1130, while the dashed line labeled 1120 indicates the threshold 25% LFL. The dashed line labeled 1140 represents the stoichiometric concentration in air discussed above in conjunction with Table 1.

In view of the many possible examples to which the principles of the disclosed invention may be applied, it should be recognized that the illustrated examples are only preferred examples of the invention and should not be taken as limiting the scope of the invention. Rather, the scope of the invention is defined by the following claims. We therefore claim as our invention all that comes within the scope and spirit of these claims.

1. An energy storage system comprising:
an enclosure comprising a first vent forming a first flow path between an interior volume of the enclosure and an environment exterior to the enclosure;
a first vent covering mounted proximate the first vent, wherein the first vent covering is selectively disposable over the first vent such that the first flow path is open when the first vent covering is in an open position and closed when the first vent covering is in a closed position, wherein the first vent covering is biased to the open position; and
an actuator coupled to the first vent covering, wherein supply of electrical power to the actuator causes the first vent covering to assume the closed position and loss of electrical power to the actuator causes the first vent covering to assume the open position.

2. The energy storage system of claim 1, wherein the enclosure further comprises a second vent forming a second flow path between an interior volume of the enclosure and the environment exterior to the enclosure.

3. The energy storage system of claim 2, further comprising at least one fan disposed in the second flow path and configured to one or both of:
(i) pull external air from the environment exterior to the enclosure into the interior volume of the enclosure; and
(ii) push internal air from the interior volume of the enclosure to the environment exterior to the enclosure.

4. (canceled)

5. The energy storage system of claim 3, further comprising a control unit configured to operate the fan to produce an air flow along the second flow path at an air flow rate that is variable.

6. (canceled)

7. The energy storage system of claim 5, further comprising at least one environmental sensor disposed within the interior volume and configured to generate a sensor measurement, and wherein the control unit is configured to operate the fan such that the air flow rate is based, at least in part, on the sensor measurement.

8. The energy storage system of claim 7, wherein the at least one environmental sensor comprises a gas detector configured to measure a concentration of at least one flammable gas, and wherein the sensor measurement generated by the gas detector represents the concentration of the at least one flammable gas.

9. The energy storage system of claim 7, wherein the at least one environmental sensor comprises a temperature sensor configured to measure a temperature within the enclosure, and wherein the sensor measurement generated by the temperature sensor represents the measured temperature.

10-11. (canceled)

12. The energy storage system of claim 5, wherein the control unit is configured to supply the electrical power to the actuator to maintain the first vent covering in the closed position.

13. The energy storage system of claim 12, wherein the control unit is positioned within the enclosure.

14. The energy storage system of claim 1, wherein the enclosure comprises a third vent forming a third flow path between the interior volume of the enclosure and the environment exterior to the enclosure, and wherein the first vent and the third vent are on opposite sides of the enclosure.

15. The energy storage system of claim 14, further comprising a second vent covering mounted proximate the third vent, wherein the second vent covering is selectively disposable over the third vent such that the third flow path is open when the second vent covering is in an open position and closed when the second vent covering is in a closed position, and wherein the second vent covering is biased to the open position.

16. The energy storage system of claim 1, further comprising at least one gas detector disposed within the interior volume of the enclosure to measure a concentration of at least one flammable gas.

17. (canceled)

18. The energy storage system of claim 1, wherein the first vent covering comprises a louver and a biasing member coupled to the louver to bias the louver to the open position.

19-20. (canceled)

21. The energy storage system of claim 1, wherein the enclosure has an upper portion and a lower portion, wherein the first vent is formed in the upper portion, and further comprising one or more battery stacks disposed in a portion of the interior volume within the lower portion.

22-23. (canceled)

24. A method comprising:
detecting a flammable gas at a concentration above a predetermined limit within an interior volume of an enclosure; and
responsive to the detecting the flammable gas, opening a first flow path formed between an interior volume of the enclosure and an environment exterior to the enclosure by a first vent of the enclosure.

25. The method of claim 24, wherein the detecting the flammable gas is performed with a gas detector positioned within the enclosure, and wherein the opening the flow path is performed with a control unit that receives a sensor measurement from the gas detector that represents a gas concentration of the flammable gas.

26. The method of claim 24, wherein opening the first flow path comprises disconnecting a supply of electrical power to an actuator configured to operate a covering of the first vent.

27. (canceled)

28. The method of claim 24, further comprising operating at least one fan disposed in a second flow path formed between the interior volume of the enclosure and the environment exterior to the enclosure by a second vent of the enclosure.

29. The method of claim 28, wherein operating the at least one fan disposed in the second flow path comprises operating the at least one fan to pull air into the interior volume of the enclosure from the environment exterior to the enclosure.

30. The method of claim 28, wherein operating the at least one fan disposed in the second flow path comprises operating the at least one fan to push air out of the interior volume of the enclosure to the environment exterior to the enclosure.

31-32. (canceled)
